(19) United States
(12) Patent Application Publication
(10) Pub. No.: US 2024/0370591 A1
(43) Pub. Date: Nov. 7, 2024

(54) HARDWARE COUNTERMEASURES IN A FAULT TOLERANT SECURITY ARCHITECTURE

(71) Applicant: TEXAS INSTRUMENTS INCORPORATED, Dallas, TX (US)

(72) Inventor: Amritpal Singh Mundra, Allen, TX (US)

(21) Appl. No.: 18/772,617

(22) Filed: Jul. 15, 2024

Related U.S. Application Data
(63) Continuation of application No. 17/391,132, filed on Aug. 2, 2021, now Pat. No. 12,073,006.
Application No. 17/391,132 is a continuation of application No. 16/048,711, filed on Jul. 30, 2018, now Pat. No. 11,080,432.

(51) Int. Cl. G06F 21/75; G06F 21/85; H03K 17/22; H04L 9/00

(52) U.S. Cl. CPC G06F 21/755; G06F 21/85; H03K 17/223; H04L 9/004

(57) ABSTRACT

A system, e.g., system-on-chip (SoC), is provided that includes security control registers that include security flags for security critical assets of the SoC, in which each security flag includes multiple bits. In an example, a system includes a processor; a set of devices including a first device that includes a set of registers; and a set of firewalls, each configured to couple the processor to a respective device of the set of devices. The set of registers stores a first value determined by a plurality of bits, and the first device determines whether to cause a first firewall of the set of firewalls to operate in a bypass mode based on a relationship between values of adjacent bits of the first value.

### CROSS-REFERENCE TO RELATED APPLICATIONS

This application is a continuation of U.S. patent application Ser. No. 17/391,132, filed Aug. 2, 2021, which is a continuation of U.S. patent application Ser. No. 16/048,711, filed Jul. 30, 2018 (now U.S. Pat. No. 11,080,432), each which is incorporated by reference herein in its entirety.

### BACKGROUND

The integrity and trustworthiness of embedded devices in industrial and automotive applications is critical as disruptions in operation may have direct security consequences. Fault attacks are employed to attempt to compromise such devices. A fault attack is some form of intentional manipulation of an embedded device with the goal of causing an error that puts the device in an unintended, vulnerable state that, for example, allows access to security critical information or disables internal protection mechanisms. Types of fault attacks include clock fault injection, voltage fault injection, electromagnetic fault injection, and optical fault injection.

### SUMMARY

Examples of the present disclosure relate to methods and devices that provide hardware countermeasures in a fault tolerant security architecture. In one aspect, a system includes a processor; a set of devices including a first device that includes a set of registers; and a set of firewalls, each configured to couple the processor to a respective device of the set of devices. The set of registers is configured to store a first value determined by a plurality of bits; and the first device is configured to determine whether to cause a first firewall of the set of firewalls to operate in a bypass mode based on a relationship between values of adjacent bits of the first value.

In another aspect, a system includes a processor; a first firewall and a second firewall; a memory coupled to the first firewall; and a security manager coupled to the second firewall. The security manager includes a set of registers configured to store a first set of bits defining a first value and a second set of bits defining a second value. The security manager is configured to cause the first firewall to operate in a bypass mode based on the first value; and the security manager is further configured to perform at least one of the following: permit execution of a function based on the second value, and prohibit modification of any of the first set of bits based on the second value.

In still another aspect, a method of operating a device includes receiving a power on reset (POR) signal; latching the POR signal, using a latch circuit, outputting a latched POR signal to components of the device, and clearing the latch circuit in response to receipt of a signal indicating that POR is complete with respect to the components; reading, from a memory, a first set of bits indicating a device type and reading a second set of bits for validating the first set of bits; validating the device type using the second set of bits; reading a plurality of security values, each having multiple bits, from the memory; and storing the plurality of security values in a plurality of registers of the device, including storing a first security value of the plurality of security values in a first register of the plurality of registers, in which the first security value determines whether to set a firewall of the device to a bypass mode.

### BRIEF DESCRIPTION OF THE DRAWINGS

FIG. 1 is a block diagram of an example system-on-chip (SoC) incorporating a fault tolerant security architecture;

FIG. 2 is a simplified block diagram of a device management security controller (DMSC) of the SoC of FIG. 1;

FIG. 3 is a block diagram of reset circuitry of the SoC of FIG. 1; and

FIG. 4 is a flow diagram of a method for operating the SoC of FIG. 1.

### DETAILED DESCRIPTION

Specific examples of the disclosure will now be described in detail with reference to the accompanying figures. Like elements in the various figures are denoted by like reference numerals for consistency.

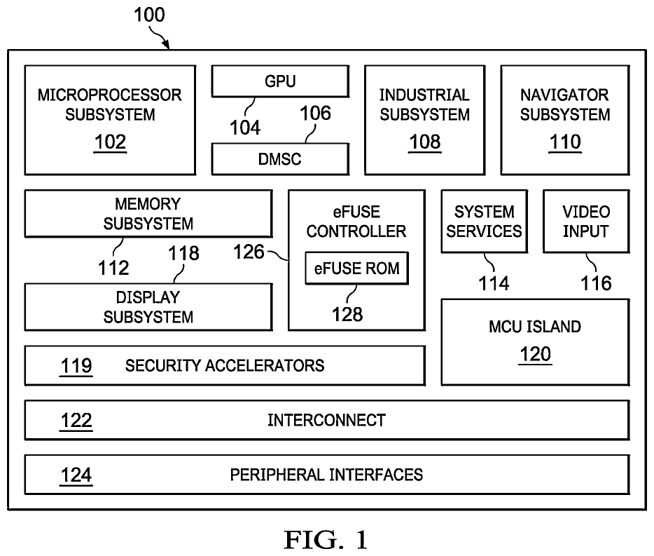

FIG. 1 is a block diagram of an example system-on-chip (SoC) 100 incorporating a fault tolerant security architecture with various hardware implemented countermeasures against fault attacks. The SoC 100 includes a microprocessor subsystem 102 with multiple processing cores and shared memory, a graphics processing unit (GPU) 104, an industrial subsystem 108 providing industrial communication interfaces, and a navigator subsystem 110 with direct memory access and queue management components. The SoC 100 further includes a memory subsystem 112, system services 114 including timers and peripheral direct memory access, a video input 116 subsystem including camera and video input interfaces, and a display subsystem 118 including overlay management and display interfaces. In addition, the SoC 100 includes security accelerators 119 supporting various encryption standards, a microcontroller (MCU) island 120 including an MCU subsystem with separate voltages, clocks, and peripherals, and peripheral interfaces 124 including, for example, automotive interfaces, control interfaces, Ethernet, universal serial bus (USB), and general-purpose input/output (GPIO). A high-speed interconnect 122 provides a bus architecture between the various components of the SoC 100.

The SoC 100 further includes an eFuse controller 126 which includes an eFuse ROM 128, e.g., configuration storage. The eFuse ROM 128 is a bank of fuses arranged in an array of rows and columns that may be used to store security keys and various boot configuration values, including configuration values such as the device type and security flag values for the fault tolerant security architecture. The eFuse controller 126 is configured to scan the array during a power-on reset (POR) of the SoC 100 to determine which eFuses are open and which are closed, convert that information into a binary 0 or 1, and provide the binary information to relevant components of the SoC 100.

System memories and peripheral interfaces in the SoC 100 are protected by hardware firewall modules. Further, initiator side control (ISC) modules are coupled to transaction initiation components in the SoC 100 to apply security attributes to initiated transactions. The ISC modules ensure that transactions are assigned source identifiers and access privileges such that a firewall module interfaced to a target component can use this information to permit the target component to carry out selective processing based on the source and access privileges. In some examples, the SoC 100 implements a firewall/ISC architecture as described in U.S. patent application Ser. No. 15/679,307, entitled “Flexible Hybrid Firewall Architecture, filed Aug. 17, 2017, which is incorporated by reference herein.

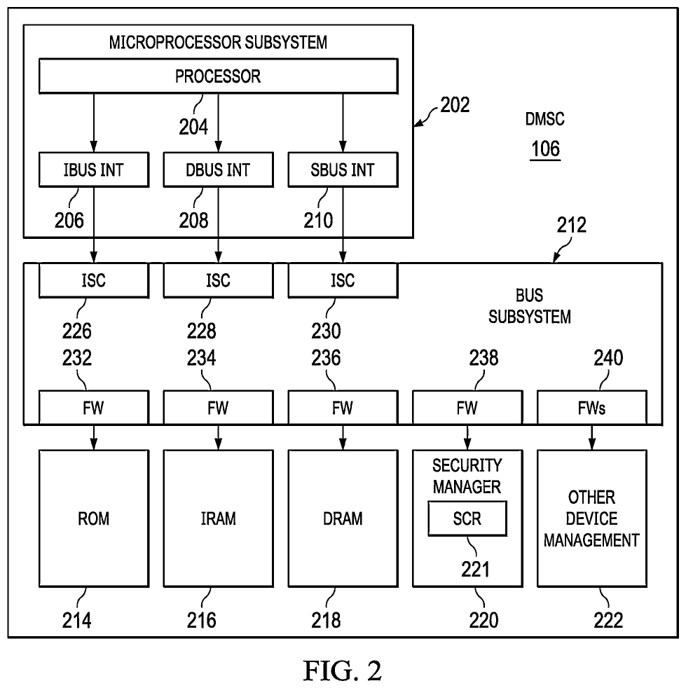

The SoC 100 further includes a device management security controller (DMSC) 106 configured to manage system services including initial boot, security, safety, and power management. FIG. 2 is a simplified block diagram of an example DMSC 106. The DMSC 106 includes a microprocessor subsystem 202 incorporating a processor 204, e.g., an ARM Cortex-M3, coupled to on-chip read-only memory (ROM) 214, on-chip instruction random access memory (IRAM) 216, on-chip data RAM (DRAM) 218, and other DMSC 106 components 220, 222 via a bus subsystem 212. The instruction bus, data bus, and system bus of the processor 204 are coupled to the bus subsystem 212 via respective bus interfaces 206, 208, 210. The on-chip read-only memory (ROM) 214 stores boot code that allows the DMSC 106 to autonomously boot and configure the rest of the SoC 100 to facilitate full device boot.

The bus subsystem 212 includes a firewall architecture for the DMSC 106. Initiator side control (ISC) modules 226, 228, 230 implemented in the bus subsystem 212 control security attributes applied to transactions initiated by the processor 204 via the bus interfaces 206, 208, 210. Further, firewall (FW) modules 232, 234, 236, 238, 240 implemented in the bus subsystem 212 control access to respective protected components of the DMSC 106, i.e., the memories 214, 216, 218, the security manager 220, and other device management components 222.

Other device management components 222 include components for power management, interrupt aggregation, memory fault detection and correction, debug authorization, configuration of the SoC 100 firewall modules, timer management, and an encryption engine. Access to each of the components 222 is controlled by a respective FW of the FWs 240.

The DMSC 106 acts as the security master of the SoC 100, controlling the initial security configuration at boot time and controlling the security critical assets of the SoC 100 during run time. Security configurations of security critical assets such as emulation control, debugging, ISC modules, and firewall modules are performed by the DMSC 106. The security manager 220 incorporates much of the security management functionality of the DMSC 106 including SoC 100 security management, device type control, emulation control, debug control, and key management.

The security manager 220 is one of the initial blocks enabled at a power on reset (POR) of the SoC 100 in order to configure the security settings of the SoC 100 prior to bringing the rest of the SoC 100 out of reset. As an initial action, the security manager 220 decodes a device type of the SoC 100, e.g., test, emulator, high security, or general purpose, received from the eFuse ROM 128. Each device type indicates different capabilities for test, debug, and emulation as well as different behavior in operating mode, thus indicating whether security mechanisms should be relaxed or enforced. The security manager 220 determines the security level based on the device type and changes values in security control registers 221 accordingly.

A hardware countermeasure is employed to protect the device type information supplied to the security manager 220 because the device type is read from the eFuse ROM 128 in a different voltage domain from that of the security manager 220. A voltage crossing between domains operating at different voltages can cause signal corruption. In general, the hardware countermeasure involves including a set of validation bits when signaling a set of security critical bits. In some examples, the value of the set of validation bits is the inverse of the value of the security critical bits. The recipient of the security critical bits and the validation bits can use the validation bits to confirm that the security critical bits are valid before relying on the security critical bits.

In one example embodiment, the device type is signaled as a 16-bit value of two sets of eight bits that are bit-wise-inverse of each other. That is, eight security critical bits in the 16-bit value include the actual device type and the other eight bits are validation bits that are the inverse of the eight security critical bits. The security manager 220 verifies that no corruption has occurred during transfer as part of determining the device type as illustrated in the example pseudo code of Table 1. In this pseudo code, device_type_raw is the 16-bit value received from the eFuse ROM 128.

TABLE 1

If (device_type_raw [7:0] != (~(device_type_raw[15:8])))
begin

device_type = BAD;

end
else
begin

decode device type;

end

The security manager 220 outputs various security control signals to security critical hardware assets based on the values of security flags initially configured by values read from the eFuse ROM 128. The security flags are stored in security control registers 221 protected by the firewall module 228 corresponding to the security manager 220. In some examples, the security control registers 221 are memory mapped registers. Further, some of the registers 221 storing configured security flags can be locked until the next power cycle of the SoC 100 by setting security flags referred to as lock flags in the registers. Note that the combination of firewall protection and register locking provides two levels of protection for security critical assets.

To help protect security critical hardware assets, e.g., a debug port or a firewall module, from fault attacks that rely on flipping a single bit, security flags for such hardware assets are specified, stored, and output as multi-bit values rather than single bit values. Any suitable number of bits and any suitable values for the multiple bits that provide protection against fault attacks may be used. In some examples, four-bit values are used, where bit values that are equal Hamming distance away from each other, e.g., 1010, indicate access is enabled and any other value indicates that access is not enabled. Further, lock values are similarly multi-bit values.

Tables 2-6 are examples of register layouts in the security manager 220 utilizing these multi-bit values. Table 2 is a register controlling firewall bypass that includes a 4-bit lock flag and 4-bit flags controlling bypassing the DMSC 106 firewall modules and bypassing the SoC 100 firewall modules. Table 3 is a register providing master control of tracing, emulation, and debugging of the SoC 100 that includes 4-bit flags for enabling or disabling each. Tables 4-6 are registers controlling access to a key encryption key (KEK), also referred to as the random key, a master public key (MPK), and a master encryption key (MEK), respectively. Each register includes a 4-bit lock flag and 4-bit flags controlling access to the respective key.

TABLE 2

| Bits | Field | Type | Reset [updated after eFuse scan] | Description |
|---|---|---|---|---|
| 31:28 | Reserved | r/o | 0 | Reserved |
| 27:24 | Lock | r/w | 0xA | Unlock code is 0xA, if |
| | Register | | | value is anything else |
| | | | | the register locks, once |
| | | | | locked this register |
| | | | | cannot be changed till |
| | | | | POR. |
| 23:12 | Reserved | r/o | 0 | Reserved |
| 11:8 | DMSC | r/w | EMULATOR (Sub type) = Closed | Writing code 0xA will put |
| | Firewall | | (0x0) | DMSC firewall in bypass |
| | Bypass | | HIGH_SECURITY = Closed (0x0) | mode. |
| | | | GENERAL_PURPOSE = Bypass | |
| | | | (0xA) | |
| | | | TEST = Bypass (0xA) | |
| | | | BAD = Closed (0x0) | |
| 7:4 | Reserved | r/o | 0 | Reserved |
| 3:0 | SoC | r/w | EMULATOR = Closed (0x0) | Writing code 0xA will put |
| | Firewall | | HIGH_SECURITY = Closed (0x0) | all SoC firewalls in |
| | Bypass | | GENERAL_PURPOSE = Bypass | bypass mode, excluding |
| | | | (0xA) | DMSC. |
| | | | TEST = Bypass (0xA) | |
| | | | BAD = Closed (0x0) | |

TABLE 3

| Bits | Field | Type | Reset | Description |
|---|---|---|---|---|
| 31:20 | Reserved | r/o | 0 | Reserved |
| 19:16 | soc_trace_enable | r/w | EMULATOR = Enabled (0xA) | Writing code 0xA will |
| | | | HIGH_SECURITY = Closed (0x0) | allow trace for entire |
| | | | GENERAL_PURPOSE = Enabled (0xA) | SoC. |
| | | | TEST = Enabled (0xA) | |
| | | | BAD = Closed (0x0) | |
| 15:12 | Reserved | r/o | 0 | Reserved |
| 11:8 | sec_emu_enable | r/w | EMULATOR = Enabled (0xA) | Writing code 0xA will |
| | | | EMULATOR = Enabled (0xA) | allow secure |
| | | | HIGH_SECURITY = Closed (0x0) | emulation for All |
| | | | GENERAL_PURPOSE = Enabled (0xA) | SoC. |
| | | | TEST = Enabled (0xA) | |
| | | | BAD = Closed (0x0) | |
| 7:4 | Reserved | r/o | 0 | Reserved |
| 3:0 | sec_debug_enable | r/w | EMULATOR = Enabled (0xA) | Writing code 0xA will |
| | | | HIGH_SECURITY = Closed (0x0) | enable full debug for |
| | | | GENERAL_PURPOSE = Enabled (0xA) | SoC except DMSC. |
| | | | TEST = Enabled (0xA) | |
| | | | BAD = Closed (0x0) | |

TABLE 4

| Bits | Field | Type | Reset | Description |
|---|---|---|---|---|
| 31:28 | Reserved | r/o | 0 | Reserved |
| 27:24 | Lock | r/w | 0xA | Unlock code is 0xA, if value is anything else the register |
| | Config | | | locks, once locked this register cannot be changed till |
| | | | | POR. |
| 23:20 | Reserved | r/o | 0 | Reserved |
| 19:16 | KEK | r/w | 0x0 | 0xA Override KEK output to value from KEK override |
| | Override | | | registers. |
| | control | | | Else: KEK is as coming from KEK eFuses |
| 15:12 | Reserved | r/o | 0 | Reserved |
| 11:8 | SW KEK | r/w | 0xA | 0xA Write Access allowed to SW KEK register |
| | Write | | | Else: No write access |
| | Access | | | |
| 7:4 | Reserved | r/o | 0 | Reserved |
| 3:0 | SW KEK | r/w | 0xA | 0xA Read Access allowed to SW KEK register |
| | Read | | | Else: No Read access. |
| | Access | | | |

TABLE 5

| Bits | Field | Type | Reset | Description |
|---|---|---|---|---|
| 31:28 | Reserved | r/o | 0 | Reserved |
| 27:24 | Lock | r/w | 0xA | Unlock code is 0xA, if value is anything else the |
| | Config | | | register locks, once locked this register cannot be |
| | | | | changed till POR. |
| 23:20 | Reserved | r/o | 0 | Reserved |
| 19:16 | Echo | r/w | 0 | Writing code 0xA will echo MPK value in MPK read |
| | MPK in | | | only Status registers |
| | status | | | |
| | register | | | |
| 15:12 | Reserved | r/o | 0 | Reserved |
| 11:8 | MPK | r/w | 0xA | 0xA Write Access allowed |
| | Write | | | Else: No write access |
| | Access | | | |
| 7:4 | Reserved | r/o | 0 | Reserved |
| 3:0 | MPK | r/w | 0xA | 0xA Read Access allowed |
| | Read | | | Else: No Read access. |
| | Access | | | |

TABLE 6

| Bits | Field | Type | Reset | Description |
|---|---|---|---|---|
| 31:28 | Reserved | r/o | 0 | Reserved |
| 27:24 | Lock | r/w | 0xA | Unlock code is 0xA, otherwise register is locked until |
| | Config | | | next POR |
| 23:20 | Reserved | r/o | 0 | Reserved |
| 19:16 | Echo MEK | r/w | 0 | Writing code 0xA will echo MEK index value in status |
| | index | | | register |
| | value in | | | |
| | status | | | |
| | register | | | |
| 15:12 | Reserved | r/o | 0 | Reserved |
| 11:8 | MEK | r/w | 0xA | 0xA Write Access allowed |
| | Write | | | Else: No write access |
| | Access | | | |
| 7:4 | Reserved | r/o | 0 | Reserved |
| 3:0 | MEK | r/w | 0xA | 0xA Read Access allowed |
| | Read | | | Else: No Read access. |
| | Access | | | |

The security manager 220 also provides for optional security flags that can be accessed by software executed from the ROM 214. Similar to the security flags for security critical hardware assets, the optional security flags are specified, stored, and output as multi-bit values rather than single bit values too help protect these flags from fault attacks that rely on flipping a single bit. Any number of optional security flags can be provided. Any suitable number of bits and any suitable values for the multiple bits may be used. In some examples, four-bit values are used, where bit values that are equal Hamming distance away from each other, e.g., 1010, indicate the ROM-defined option associated with the flag is enabled and any other value indicates that the option is not enabled.

Table 8 is an example of a register in the security manager 220 that allows for enabling or disabling eight optional security flags. The values of these flags and usage of these flags can determined by the system designer and the values stored in the eFuse ROM 128. The initial values of these register fields are set by the security manager 220 during eFuse scanning at POR.

TABLE 8

| Bits | Field | Type | Reset | Description |
|---|---|---|---|---|
| [31:28] | Fault tolerant | r/w | 0 | If the value is 0xA, then option is enabled. |
| | ROM eFuse | | | Else: Selected option is disabled. |
| | option7 | | | |
| [27:24] | Fault tolerant | r/w | 0 | If the value is 0xA, then option is enabled. |
| | ROM eFuse | | | Else: Selected option is disabled. |
| | option6 | | | |
| [23:20] | Fault tolerant | r/w | 0 | If the value is 0xA, then option is enabled. |
| | ROM eFuse | | | Else: Selected option is disabled. |
| | option5 | | | |
| [19:16] | Fault tolerant | r/w | 0 | If the value is 0xA, then option is enabled. |
| | ROM eFuse | | | Else: Selected option is disabled. |
| | option4 | | | |
| [15:12] | Fault tolerant | r/w | 0 | If the value is 0xA, then option is enabled. |
| | ROM eFuse | | | Else: Selected option is disabled. |
| | option3 | | | |
| [11:8] | Fault tolerant | r/w | 0 | If the value is 0xA, then option is enabled. |
| | ROM eFuse | | | Else: Selected option is disabled. |
| | option2 | | | |
| [7:4] | Fault tolerant | r/w | 0 | If the value is 0xA, then option is enabled. |
| | ROM eFuse | | | Else: Selected option is disabled. |
| | option1 | | | |
| [3:0] | Fault tolerant | r/w | 0 | If the value is 0xA, then option is enabled. |
| | ROM eFuse | | | Else: Selected option is disabled. |
| | option0 | | | |

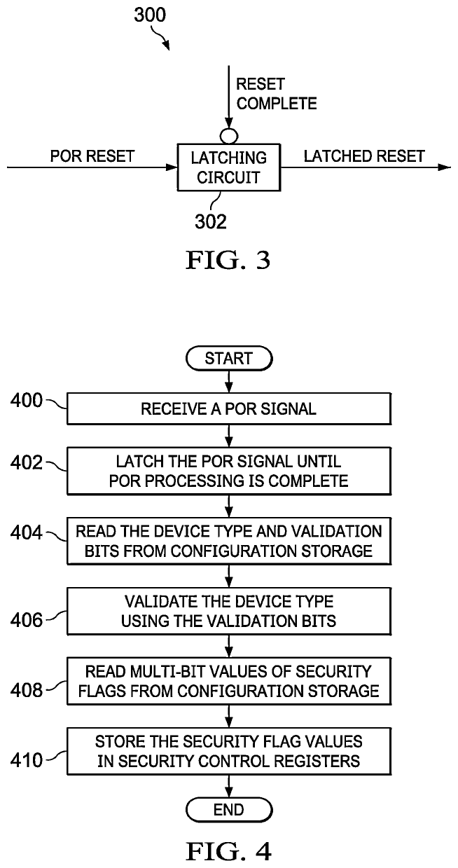

FIG. 3 is a simplified block diagram of reset circuitry 300 of the SoC 100 providing a countermeasure for fault attacks via POR. POR of a device takes some time to complete, and, once the reset signal is asserted, the signal must be asserted along enough for the reset indication to reach all modules to be reset. One possible fault attack is to assert the reset signal and then de-assert it such that the signal is not kept alive as long as expected. Such an attack can leave some modules in a vulnerable state. For example, a critical module such as a debug module can be left in a state that allows access to the device.

The reset circuitry 300 is designed to remove this sensitivity to premature de-assertion of the reset signal from the POR process. Rather than relying on propagation of the external reset signal to internal modules, the external reset signal is latched by the latching circuitry 302 and the resulting latched reset signal is propagated to the internal modules. The latching circuitry 302 can be, for example, a latch or a set/reset (SR) flip-flop. The latching circuitry 302 clears the latch only when a reset complete signal is received indicating that the POR processing is complete. Any de-assertion or re-assertion of the external POR signal is ignored until the POR processing by the SoC modules is completed and the latching circuitry 302 clears the latch.

FIG. 4 is a flow diagram of a method for operating the SoC of FIG. 1. Initially, a POR signal is received 400 in the SoC and the POR is latched 402 by the reset circuitry 300 until POR processing is complete. The bits encoding the device type and the validation bits are read 404 from configuration storage, e.g., scanned from the eFuse ROM 128, and the device type is validated 406 by the security manager 220 using the validation bits. Multi-bit values of security flags are read 408 from configuration storage, e.g., scanned from the eFuse ROM 128, and stored 410 in security control registers by the security manager 220.

### Other Examples

While the disclosure has been described with respect to a limited number of examples, those having benefit of this disclosure will appreciate that other examples can be devised which do not depart from the scope of the disclosure as described herein.

For example, the multi-bit values of the security control flags and/or the number of bits in a security control flag can differ from among the flags.

It is therefore contemplated that the appended claims will cover any such modifications of the examples as fall within the true scope of the disclosure.

What is claimed is:

1. A system comprising:
a processor;
a set of devices including a first device that includes a set of registers; and
a set of firewalls, each configured to couple the processor to a respective device of the set of devices, wherein:
the set of registers configured to store a first value determined by a plurality of bits; and
the first device is configured to determine whether to cause a first firewall of the set of firewalls to operate in a bypass mode based on a relationship between values of adjacent bits of the first value.

2. The system of claim 1, wherein the first device is configured to determine whether to cause the first firewall to operate in the bypass mode based on whether any adjacent bits of the plurality of bits determining the first value have the same value.

3. The system of claim 1, wherein:
the set of registers includes a first subset configured to store the first value, and a second subset configured to store a second value determined by a plurality of bits; and
the first device is configured to determine whether to lock the first subset and the second subset of the set of registers based on the second value.

4. The system of claim 3, wherein the first device is configured to, when the second value indicates to lock the first subset and the second subset, prohibit a change to either the first value or the second value until after a power-on-reset event.

5. The system of claim 3, wherein the first device is configured to determine whether to lock the first subset and the second subset of the set of registers based on whether any adjacent bits of the plurality of bits determining the second value have the same value.

6. The system of claim 1, wherein the first device is configured to:
receive a second value to store in the set of registers and a set of validation bits;
verify the second value based on the set of validation bits; and
determine whether to store the second value in the set of registers based on verification of the second value based on the set of validation bits.

7. The system of claim 1, wherein:
the set of registers includes a first subset configured to store the first value, and a second subset configured to store a second value; and
the first device is configured to determine whether to cause a second firewall of the set of firewalls to operate in a bypass mode based on the second value.

8. The system of claim 1, wherein the first firewall is coupled between the processor and the first device.

9. The system of claim 1, wherein:
the set of devices includes a memory; and
the first firewall is coupled between the processor and the memory.

10. The system of claim 1, wherein:
the set of registers includes a first subset configured to store the first value, and a second subset configured to store a second value; and
the first device is configured to determine whether to permit, based on the second value, execution of a function from a group consisting of: a trace function, an emulation function, and a debug function.

11. A system comprising:
a processor;
a first firewall and a second firewall;
a memory coupled to the first firewall; and
a security manager coupled to the second firewall, wherein:
the security manager includes a set of registers configured to store a first set of bits defining a first value and a second set of bits defining a second value;
the security manager is configured to cause the first firewall to operate in a bypass mode based on the first value; and
the security manager is further configured to perform at least one of the following:
permit execution of a function based on the second value, and
prohibit modification of any of the first set of bits based on the second value.

12. The system of claim 11, wherein the security manager is configured to prohibit modification of any of the first set of bits until after a power-on-reset event.

13. A method of operating a device, the method comprising:
receiving a power on reset (POR) signal;
latching the POR signal, using a latch circuit, outputting a latched POR signal to components of the device, and clearing the latch circuit in response to receipt of a signal indicating that POR is complete with respect to the components;
reading, from a memory, a first set of bits indicating a device type and reading a second set of bits for validating the first set of bits;
validating the device type using the second set of bits;
reading a plurality of security values, each having multiple bits, from the memory; and
storing the plurality of security values in a plurality of registers of the device, including storing a first security value of the plurality of security values in a first register of the plurality of registers, in which the first security value determines whether to set a firewall of the device to a bypass mode.

14. The method of claim 13, wherein the POR signal is a first POR signal, the method further comprising:
locking the first security value based on a second security value, wherein once locked, the first security value is prohibited from being changed at least until a second POR signal is received.

15. The method of claim 13, wherein each of the first and second security values consists of four bits.

16. The method of 15, wherein the firewall is set to the bypass mode when it is determined that no two adjacent bits of the first security value are the same.

17. The method of claim 13, wherein at least one of the plurality of security values is for use by software executing in the device.

18. The method of claim 13, wherein at least one of the plurality of security values is for use by a hardware component of the components.

19. The method of claim 13, wherein the validating of the device type includes determining whether no adjacent bits of the second set of bits are the same.

20. The method of claim 13, wherein the memory includes a configuration storage that includes an eFuse ROM.
